(19) United States
(12) Patent Application Publication
(10) Pub. No.: US 2007/0112115 A1
(43) Pub. Date: May 17, 2007

(54) Inorganic-organic hybrid micro-/nanofibers

(76) Inventors: Shalaby W. Shalaby, Anderson, SC (US); Michael Scott Taylor, Pendleton, SC (US)

Correspondence Address: LEIGH P. GREGORY;ATTORNEY AT LAW, PO BOX 168, CLEMSON, SC, 29633-0168, US

(21) Appl. No.: 11/599,695

(22) Filed: Nov. 15, 2006

Related U.S. Application Data
(60) Provisional application No. 60/737,021, filed on Nov. 15, 2005.

(51) Int. Cl. C08K 3/22

(52) U.S. Cl. 524/431; 524/432; 524/493; 524/435; 524/556

(57) ABSTRACT

Inorganic-organic hybrid micro-/nanofibers having a cross-sectional area not exceeding 140μ² include micro-/nanoparticulate inorganic components dispersed in an organic, absorbable or non-absorbable polymeric matrix at a weight concentration of at least about 4 percent by weight and are produced by electrostatic spinning or melt-blowing.

### CROSS-REFERENCE TO RELATED APPLICATIONS

The present application claims the benefit of prior provisional application Ser. No. 60/737,021.

### FIELD OF THE INVENTION

This invention relates to a novel family of inorganic-organic hybrid micro-/nanofibers wherein the individual fibers are true micro-/nanocomposites having an average cross-sectional area of less than 140μ² and partially adhering at the cross-points to form unique, non-woven fabrics of biomedical significance because of the composition and properties of the inorganic dispersed phase and the organic matrix, which can be easily tailored to meet special medical and/or pharmaceutical requirements for unique and/or value-added products.

### BACKGROUND OF THE INVENTION

The technology of fiber formation using melt, solution, and dry spinning has evolved considerably over the past decades to produce a great number of monofilament and multifilament yarns of many types of polymers for use in manufacturing an impressively diverse array of fibrous constructs for textile, industrial, and medical applications. Most, if not all, of the constituent fibers of these yarns were made to have cross-sectional area of at least 140μ². This is because of the limitations associated with the available fiber formation processing methods. Meanwhile, interest in cost reduction of certain fabric constructs and advances in surface technology have driven the textile industry to develop non-woven fabrics comprising high surface area microfibers using the process of melt-blowing. And many of the non-woven fabrics made by this technology have found immediate use in medical textiles and a few medical devices where value-added properties could be acquired by incorporating surface coating and/or organic additives, such as antimicrobial agents. The development of new antimicrobial, non-woven fabrics designed to release their bioactive agents at controlled rates was disclosed by one of the present inventors [U.S. Pat. Nos. 6,596,657 and 6,780,799 (2004)]. Unfortunately, certain polymers of great potential use in medical and pharmaceutical applications cannot be easily converted to microfibers by melt-blowing, because they undergo thermal degradation in the molten state. This directed the attention of a few investigators to the use of a more recent technology such as room temperature (or near room temperature) electrostatic spinning (or electrospinning) of solutions of selected types of biomedically significant polymers, not only to microfibers but also to nanofibers. Intrigued by the ability to convert biomaterials to high surface area, micro-/nanofibers under mild conditions, a few investigators used limited amounts, not exceeding about 3 weight percent, of finely divided organic materials, such as collagen or bioactive agents, in polymer solutions geared for electrospinning to produce composite micro-/nanofibers. However, the prior art failed to produce composites of uniformly dispersed solid micro-/nanoparticles in general, and particularly inorganic material having densities that exceed the density of the polymer solution. These facts and growing contemporary needs to harness the electrospinning technology toward producing micro-/nanofibers comprising a wide variety of biomedically significant inorganic additives at clinically significant levels provided a strong incentive to pursue the present invention.

### SUMMARY OF THE INVENTION

The present invention generally is directed to an inorganic-organic hybrid micro-/nanofiber comprising at least one type of inorganic micro-/nanoparticle dispersed in an organic polymeric matrix at a weight concentration of at least about 4 percent to produce hybrid composite fibers of variable cross-sectional area not exceeding 140μ², wherein the inorganic micro-/nanoparticles are selected from the group represented by sulfates of di-, tri- and tetravalent metals, phosphate salts, polymeric phosphate glasses, polymeric phosphate glass ceramics, phosphate ceramics, ZrO₂, and basic bismuth carbonate. Specifically, (1) the sulfates may be salts of at least one of the metals selected from the group Mg, Ca, Ba, Sr, Zr, Zn, Bi, and Fe; (2) the phosphate salts are at least one of those selected from the group represented by CaHPO₄, K₂HPO₄, KH₂PO₄, Na₂HPO₄, NaH₂PO₄, Ca₃(PO₄)₂, Ca₁₀(OH)₂(PO₄)₆, and Ca₂P₂O₇; and (3) the polymeric phosphate glasses are derived from P₂O₅, CaO, and at least one oxide selected from the group represented by ZnO, SrO, Na₂O, K₂O, Sio₂, Fe₂O₃, and ZrO₂.

Another general aspect of this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the organic polymeric matrix is a thermoplastic absorbable polyester comprising chain sequences derived from at least one cyclic monomer selected from the group represented by ε-caprolactone, glycolide, a lactide, p-dioxanone, 1,5-dioxepan-2-one, trimethylene carbonate, and a morpholinedione.

A specific aspect of this invention deals with an inorganic-organic hybrid micro-/nanofiber comprising at least one type of inorganic micro-/nanoparticle dispersed in an organic polymeric matrix at a weight concentration of at least about 4 percent to produce hybrid composite fibers of variable cross-sectional area not exceeding 140μ², wherein the organic polymeric matrix is an absorbable polyether-ester and more specifically, the absorbable polyether-ester is derived from a polyethylene glycol end-grafted with at least one cyclic monomer selected from the group represented by ε-caprolactone, glycolide, a lactide, trimethylene carbonate, p-dioxanone, 1,5-dioxepan-2-one and a morpholinedione.

Another specific aspect of the invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the organic polymeric matrix is formed of a methacrylate polymer derived from at least one monomer selected from the group represented by methyl methacrylate, hydroxyethyl methacrylate, n-butyl methacrylate, isobutyl methacrylate, and n-hexyl methacrylate. In addition, the organic polymeric matrix can be a copolymer of methyl methacrylate and at least one monomer selected from the group represented by N-vinyl pyrrolidone, N-vinyl caprolactam, vinyl pyridine, vinyl acetate, methacrylic acid, acrylic acid, maleic anhydride, and itaconic anhydride.

A clinically relevant aspect of this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the inorganic particles comprise at least one radiopaque compound selected from the group represented by ZrO₂, basic bismuth carbonate, and BaSO₄ and wherein the organic polymeric matrix comprises polymethyl methacrylate.

A specific aspect of this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the organic polymeric matrix comprises a segmented polyaxial copolyester derived from two or more cyclic monomers selected from the group represented by ε-caprolactone, a lactide, glycolide, trimethylene carbonate, p-dioxanone, 1,5-dioxepan-2-one, and a morpholinedione. Alternatively, the organic polymeric matrix comprises an aliphatic oxalate polymer.

From a processing standpoint, this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area, not exceeding 140μ², wherein the fibers are made using an electrostatic spinning process. Alternatively, the fibers are made using a melt-blowing process.

From a medical application perspective, this invention deals with and inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the fibers are (1) in the form of a flat, non-woven sheet with the constituent fibers surface-adhering at the cross-points; (2) in the form of a flexible, non-woven tube with the constituent fibers surfaces adhering at the cross-points; (3) intended for use as an absorbable orthopedic or dental device or component thereof which supports bone regeneration; and/or (4) made to contain at least one bioactive agent selected from the group known to have antimicrobial and tissue growth promoting activities.

### DETAILED DESCRIPTION OF PREFERRED EMBODIMENTS

Advances in material science in recent years have furthered significantly our appreciation of the exponential change in properties of materials as their size approaches micrometer and nanometer scales, which is associated with a substantial increase in the surface-to-volume ratio and most often, unique changes in the surface energy of these micro/nano systems. Such interest in these systems led to the creation of what is known as the nanotechnology, which, for all practical purposes, deals with microparticles as well as nanoparticles. A major segment of the micro-/nanotechnology relates to inorganic catalysts and organic micro-/nanospheres. In the area of fibers, the term microfibers was commonly used after the development of melt-blown, non-woven fabrics. More recently, micro-/nanofibers and non-woven fabrics formed therefrom are produced by electrostatic spinning (or electrospinning) of polymer solutions or melts. Although a number of investigators have been exploring the use of electrospinning to produce non-woven fabrics comprising absorbable micro-/nanofibers in the form of scaffolds for tissue engineering, the combined application of practically all tenets of the micro-/nanotechnology in one system could not be found in the prior art. And, accordingly, this invention deals with incorporating high-density inorganic micro-/nanoparticles of physicochemical and biological significance as a uniformly dispersed phase in organic absorbable or non-absorbable polymeric matrices as components of micro-/nanofibers at relatively high concentrations, exceeding 4 weight percent, to meet highly demanding biomedical and/or pharmaceutical requirements of devices made fully or in part therefrom.

The production of the micro-/nanofibers, subject of this invention, can be achieved using a special electrospinning method of high viscosity polymer solutions or molten polymers, which may be exposed to an ultrasonic field to maintain the high density inorganic component, uniformly dispersed prior to being electrospun. Most of the inorganic components are highly polar or ionic materials, which maintain their dispersion in the matrix during electrospinning, which in turn, undergoes maximum stream splitting to produce relatively small diameter fibers. To maximize the stream splitting even further, a small amount of leachable (can be easily extracted from electrospun article) electrolytes can be added to the electrospinning dope. The production of higher diameter fibers than those achievable by solution or melt electrospinning can be attained using traditional melt-blowing, where the hot air- or nitrogen-created turbulence maintains the uniform distribution of the high density inorganic components in the organic matrix.

Depending on the intended application of the micro-/nanofibers, the matrix can be made of (1) at least one absorbable polymer to produce absorbable implants such as surgical meshes, which may also contain at least one bioactive agent of the antimicrobial and tissue growth promoter types; (2) at least one non-absorbable polymer to produce permanent implants such as those used in orthopedic and dental applications, which may contain at least one bioactive agent having antimicrobial and tissue growth promoting activities; and (3) one or more absorbable polymer(s) to produce scaffolds for use in bone and/or cartilage regeneration, which also may have the inorganic components of the types capable of releasing inorganic ions needed for mineralization, e.g., (PO4)⁻³ and Ca⁺², to produce their microporous pads that may be impregnated with an absorbable gel for use as a so-called mechanical bone wax.

This invention deals in general with an inorganic-organic hybrid micro-/nanofiber comprising at least one type of inorganic micro-/nanoparticles dispersed in an organic polymeric matrix at a weight concentration of at least 4 percent to produce hybrid composite fibers of variable cross-sectional area not exceeding 140μ², wherein the inorganic micro-/nanoparticles are selected from the group represented by sulfates of multivalent metals, phosphate salts, polymeric phosphate glasses, polymeric phosphate glass ceramics, phosphate ceramics, ZrO₂, and basic bismuth carbonate. Specifically, (1) the multivaltent metal may be selected from the group Mg, Ca, Ba, Sr, Zr, Zn, Bi, and Fe;, (2) the phosphate salts are at least one of those selected from the group represented by CaHPO₄, K₂HPO₄, KH₂PO₄, Na₂HPO₄, NaH₂PO₄, Ca₃(PO₄)₂, Ca₁₀(OH)₂(PO₄)₆, and Ca₂P₂O₇; and (3) the polymeric phosphate glasses are derived from P₂O₅, CaO, and at least one oxide selected from the group represented by ZnO, SrO, Na₂O, K₂O, SiO₂, Fe₂O₃, and ZrO₂.

Another general aspect of this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the organic polymeric matrix is a thermoplastic absorbable polyester comprising chain sequences derived from one or more cyclic monomer selected from the group represented by ε-caprolactone, glycolide, a lactide, p-dioxanone, 1,5-dioxepan-2-one, trimethylene carbonate, and a morpholinedione.

A specific aspect of this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the organic polymeric matrix is an absorbable polyether-ester and more specifically, the absorbable polyether-ester is derived from a polyethylene glycol end-grafted with at least one cyclic monomer selected from the group represented by ε-caprolactone, glycolide, a lactide, trimethylene carbonate, p-dioxanone, 1,5-dioxepan-2-one and a morpholinedione.

Another specific aspect of the invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the organic polymeric matrix comprise a methacrylate polymer derived from one or more monomer selected from the group represented by methyl methacrylate, hydroxyethyl methacrylate, n-butyl methacrylate, isobutyl methacrylate, and n-hexyl methacrylate. In addition, the organic polymeric matrix can be a copolymer of methyl methacrylate and at least one monomer selected from the group represented by N-vinyl pyrrolidone, N-vinyl caprolactam, vinyl pyridine, vinyl acetate, methacrylic acid, acrylic acid, maleic anhydride, and itaconic anhydride.

A clinically relevant aspect of this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the inorganic particles comprise at least one radiopaque compound selected from the group represented by ZrO₂, basic bismuth carbonate, and BaSO₄ and wherein the organic polymeric matrix comprises polymethyl methacrylate.

A specific aspect of this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the organic polymeric matrix comprises a segmented polyaxial copolyester derived from two or more cyclic monomers selected from the group represented by ε-caprolactone, a lactide, glycolide, trimethylene carbonate, p-dioxanone, 1,5-dioxepan-2-one, and a morpholinedione. Alternatively, the organic polymeric matrix comprises an aliphatic oxalate polymer.

From a processing standpoint, this invention deals with an inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area, not exceeding 140μ², wherein the fibers are made using an electrostatic spinning process. Alternatively, the fibers are made using a melt-blowing process.

From a medical application perspective, this invention deals with and inorganic-organic hybrid micro-/nanofiber comprising at least one type of inorganic micro-/nanoparticle dispersed in an organic polymeric matrix at a weight concentration of at least 4 percent to produce hybrid composite fibers of variable cross-sectional area not exceeding 140μ², wherein the fibers are (1) in the form of a flat, non-woven sheet with the constituent fibers surface-adhering at the cross-points; (2) in the form of a flexible, non-woven tube with the constituent fibers surfaces adhering at the cross-points; (3) intended for use as an absorbable orthopedic or dental device or component thereof which supports bone regeneration; and/or (4) made to contain at least one bioactive agent selected from the group known to have antimicrobial and tissue growth promoting activities.

Further illustrations of the present invention are provided by the following examples:

### EXAMPLE 1

### General Method of Preparation And Characterization of Absorbable Phosphate Glasses

Preparation of these glasses requires the use of certain intermediate compounds which, upon heating in the early stages of glass formation produce their respective oxides, water vapor, carbon dioxide, and/or ammonia gas. This requires adjusting the initial stoichiometry of the glass precursors to account for the expected initial mass loss due to vapor or gas evolution and staging the heating process to prevent premature, uncontrolled gas evolution at the early stages of glass formation. An illustration of the changes in mass of typical gas- or vapor-producing starting compounds upon thermal conversion to their respective oxides is given below:

| Starting | Vapor or | Resulting |
|---|---|---|
| Compound | Gas Evolved | Oxide |
| K₂H₂PO₄ | H₂O | P₂O₅ |
| Na₂H₂PO₄ | H₂O | Na₂O, P₂O₅ |
| (NH₄)H₂PO₄ | H₂O, NH₃ | P₂O₅ |
| SiO₂•xH₂O | H₂O (10.6 wt %) | SiO₂ |

To form these glasses, as per the teaching of U.S. Pat. No.5,874,509, predetermined weights of the powdered starting components are thoroughly mixed and transferred into porcelain crucibles (Coors, 15 mL capacity) and heated in a Branstead Thermolyne-62700 muffle furnace from room temperature to 300° C. at a rate of approximately 10° C./min., followed by a heating rate of 15°/min. to reach 500° C. During this heating period, the mixture undergoes loss of water, carbon dioxide, and/or ammonia, depending on its composition. Melting then occurs between 700° C. and 1100° C. Once the melt appears clear and homogeneous (usually between 800-900° C.), the glass is poured onto a steel mold and annealed at 200° C. for 15-30 minutes and allowed to slowly cool to room temperature. Melts are preferably poured onto a stainless steel plate at the lowest temperature possible to reduce volatilization of P₂O₅.

For size reduction, the resulting glass is first ground at room temperature using a Wiley Mill and sieved to isolate two crops of particles having average diameters not exceeding 100μ and 500μ. The two crops are then subjected separately to cryogenic size reduction at liquid nitrogen temperature using a Spex 6850 Freezer Mill. In both cases, the size reduction is pursued for the required period of time to produce five new crops having different particle size distribution, corresponding namely to diameter ranges of about <1 to 5μ average, 5 to 10μ, 10 to 50μ, 50 to 100μ, and 100 to 300μ for the first, second, third, fourth, and fifth crops, respectively. The final products are isolated and dried at 60° C. under reduced pressure, prior to charactering and mixing as components of the precursors system.

The resulting glasses are characterized for (1) identity and composition using FTIR, elemental microanalysis, and electron spectroscopy for chemical analysis (ESCA); (2) thermal property and morphology using high temperature DSC and X-ray diffraction methods; and (3) particle size and particle size distribution and surface morphology using particle size analyzer and scanning electron microscopy.

### EXAMPLE 2

### Preparation of A Typical Calcium Phosphate Glass Composition (PH-G)

Using the general method for glass formation, size reduction, and characterization as described in Example 1, calcium phosphate having the following molar composition of the oxide precursors is produced: P₂O₅, 62%; Na₂O, 15%; CaO, 18%; ZnO, 5%

### EXAMPLE 3

### Preparation of A Typical Absorbable Elastomeric Polyester (AEP)

A polyaxial segment copolyester was prepared using a polyaxial amorphous trimethylene carbonate/ε-caprolactone/glycolide copolymeric initiator, end-grafted with a mixture of ι-lactide and ε-caprolactone as per a typical polymerization scheme described in U.S. Pat. Nos. 6,462,169 and 6,780,799. A typical mole ratio of polymeric initiator sequences to that of the end-grafted chain sequences is about 55/45. The polymer was isolated, purified, and characterized as described in U.S. Pat. No. 6,462,169.

### EXAMPLE 4

### Typical Electrospinning Scheme And Characterization of Hybridized Micro-/Nanofibers (HMNF)

In preparation for the electrospinning of the precursors of a typical HMNF such as the one based on PH-G and AEP, the following steps are pursued:

(1) Preparation of PH-G Micro-/Nanoparticles

This is pursued by cryogenic grinding at liquid nitrogen temperature in a freezer/mill (Spex 6850). The particles are filtered through a 5μ sieve with the assistance of a sonicating source in an organic solvent (e.g., acetone). The particles are separated from the solvent by centrifugation and then dried under reduced pressure at a temperature between 25° C. and 1 00° C., depending on the organic solvent used.

(2) Preparation of the Electrospinning Mixture of PH-G And AEP

AEP is first dissolved in solvent (e.g., CHCl₃ or a mixture of CHCl₃ and CH₂Cl₂) to obtain a 20-30% concentration, depending on the polymer molecular weight and desired fiber diameter. In a separate container, a predetermined amount of PH-G particles are mixed with a small amount of Tween-20 solution in the selected solvent system. This mixture is sonicated for at least one hour to insure full dispersion of the Tween-coated particles in the solvent. The AEP solution and PH-G dispersion are mixed and then sonicated prior to transferring to a non-conductive syringe barrel, which is part of the electrospinning apparatus.

(3) Electrospinning

The electrospinning is conducted using required electrospinning components and the following conditions: (a) +10-25 kV charge at needle tip; (b) −15-0 kV charge on collector drum; (c) 16-22 g blunt end needle; (d) 0.02-0.15 mL/min solution flow rate; and (e) 5-15″ tip-to-collector distance. And the micro-/nanofibers are collected on a stainless steel drum. After drying under reduced pressure, the non-woven fabric is removed from the drum and characterized by fiber morphology (SEM), concentration of inorganic component in fabric (pyrolysing the inorganic component and weighing residual inorganics or by extracting the polymer and weighing the dry inorganics).

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims. Moreover, Applicants hereby disclose all subranges of all ranges disclosed herein. These subranges are also useful in carrying out the present invention.

What is claimed is:

1. An inorganic-organic hybrid micro-/nanofiber comprising inorganic micro-/nanoparticles dispersed in an organic polymeric matrix at a weight concentration of at least about 4 weight percent and having a variable cross-sectional area of less than about 140μ.

2. An inorganic-organic hybrid micro-/nanofiber as in claim 1 wherein the inorganic micro-/nanoparticles are selected from the group consisting of sulfates of multivalent metals, phosphate salts, polymeric phosphate glasses, polymeric phosphate glass ceramics, phosphate ceramics, ZrO₂, and basic bismuth carbonate.

3. An inorganic-organic hybrid micro-/nanofiber as in claim 2 wherein the multivalent metals are selected from the group consisting of Mg, Ca, Ba, Sr, Zr, Zn, Bi, and Fe.

4. An inorganic-organic hybrid micro-/nanofiber as in claim 2 wherein the phosphate salts are at least one of those selected from the group consisting of CaHPO₄, K₂HPO₄, KH₂PO₄, Na₂HPO₄, NaH₂PO₄, Ca₃(PO₄)₂, Ca₁₀(OH)₂(PO₄)₆, and Ca₂P₂O₇.

5. An inorganic-organic hybrid micro-/nanofiber as in claim 2 wherein the polymeric phosphate glasses are derived from P₂O₅, CaO, and at least one oxide selected from the group consisting of ZnO, SrO, Na₂O, K₂O, SiO₂, Fe₂O₃, and ZrO₂.

6. An inorganic-organic hybrid micro-/nanofiber as in claim 1 wherein the organic polymeric matrix is a thermoplastic absorbable polyester having chain sequences derived from at least one cyclic monomer selected from the group consisting of ε-caprolactone, glycolide, a lactide, p-dioxanone, 1,5-dioxepan-2-one, trimethylene carbonate, and a morpholinedione.

7. An inorganic-organic hybrid micro-/nanofiber as in claim 1 wherein the organic polymeric matrix comprises an absorbable polyether-ester.

8. An inorganic-organic hybrid micro-/nanofiber as in claim 7 wherein the absorbable polyether-ester is derived from a polyethylene glycol end-grafted with at least one cyclic monomer selected from the group consisting of ε-caprolactone, glycolide, a lactide, trimethylene carbonate, p-dioxanone, 1,5-dioxepan-2-one and a morpholinedione.

9. An inorganic-organic hybrid micro-/nanofiber as in claim 1 wherein the organic polymeric matrix comprise a methacrylate polymer derived from at least one monomer selected from the group consisting of methyl methacrylate, hydroxyethyl methacrylate, n-butyl methacrylate, isobutyl methacrylate, and n-hexyl methacrylate.

10. An inorganic-organic hybrid micro-/nanofiber as in claim 1 wherein the organic polymeric matrix comprises a copolymer of methyl methacrylate and at least one monomer selected from the group consisting of N-vinyl pyrrolidone, N-vinyl caprolactam, vinyl pyridine, vinyl acetate, methacrylic acid, acrylic acid, maleic anhydride, and itaconic anhydride.

11. An inorganic-organic hybrid micro-/nanofiber as in claim 1 wherein the inorganic particles comprise at least one radiopaque compound selected from the group consisting of ZrO₂, basic bismuth carbonate, and BaSO₄, and wherein the organic polymeric matrix comprises polymethyl methacrylate.

12. An inorganic-organic hybrid micro-/nanofiber as in claim 1 wherein the organic polymeric matrix comprises a segmented polyaxial copolyester derived from two or more cyclic monomers selected from the group consisting of ε-caprolactone, a lactide, glycolide, trimethylene carbonate, p-dioxanone, 1,5-dioxepan-2-one, and a morpholinedione.

13. An inorganic-organic hybrid micro-/nanofiber as in claim 1 wherein the organic polymeric matrix comprises an aliphatic oxalate polymer.

14. An inorganic-organic hybrid micro-/nanofiber as in claim 1 formed by an electrostatic spinning process.

15. An inorganic-organic hybrid micro-/nanofiber as in claim 1 formed by a melt-blowing process.

16. An inorganic-organic hybrid micro-/nanofiber as in claim 1 in the form of a flat, non-woven sheet with constituent fibers surfaces adhering at cross-points.

17. An inorganic-organic hybrid micro-/nanofiber as in claim 1 in the form of a flexible, non-woven tube with constituent fibers surfaces adhering at cross-points.

18. An inorganic-organic hybrid micro-/nanofiber as in claim 1 for use as an absorbable orthopedic or dental device or component for supporting bone regeneration.

19. An inorganic-organic hybrid micro-/nanofiber as in claim 1 further including at least one bioactive agent selected from the group consisting of antimicrobial agents and tissue growth promoting agents.
